(19) United States
(12) Patent Application Publication
(10) Pub. No.: US 2007/0222623 A1
(43) Pub. Date: Sep. 27, 2007

(54) Method and system for producing animal sounds

(76) Inventors: Mark Wiliams, Moss Beach, CA (US); Steven Cass, Frewsburg, NY (US)

Correspondence Address: The Bilicki Law Firm, P.C., 1285 North Main Street, Jamestown, NY, 14701, US

(21) Appl. No.: 11/385,143

(22) Filed: Mar. 20, 2006

(51) Int. Cl. G08B 23/00

(52) U.S. Cl. 340/573.2

(57) ABSTRACT

A system for reproducing animal sounds comprising a transmitting unit having a user interface with at least one input selector corresponding to at least one animal sound, wherein the transmitting unit is adapted to generate and transmit a message indicative of the at least one animal sound selected at the user interface over a communications medium. The system for reproducing animal sounds also includes a receiving unit having a memory with the at least one animal sound stored therein. The first receiving unit is coupled to the communications medium for receiving the message from the transmitting unit, for extracting the at least one animal sound from said memory based on the message, and to play back the at least one animal sound.

### BRIEF DESCRIPTION OF THE DRAWINGS

FIG. 1 illustrates a block diagram of a receiving unit of a system for producing animal sounds;

FIG. 2 illustrates a block diagram of a transmitting unit of a system for producing animal sounds.

FIG. 3 illustrates a system for producing animal sounds.

### DETAILED DESCRIPTION OF EMBODIMENTS OF THE INVENTION

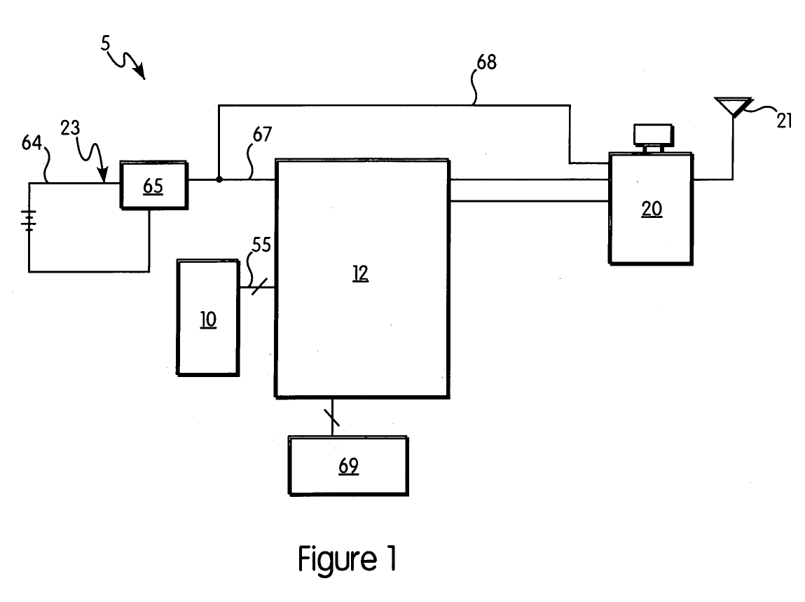

Referring to FIGS. 1-3, an embodiment of a system 1 for producing animal sounds includes a transmitting unit 5 and at least one receiving unit 6. However, additional receiving units 7-8 may be employed to produce a moving or stereo sound effect, as will be discussed in detail below. Transmitting unit 5 transmits a signal to one or more remote receiving units 6-8 in order to cause one or more of receiving units 6-8 to play a sound in a location remote to transmitting unit 5.

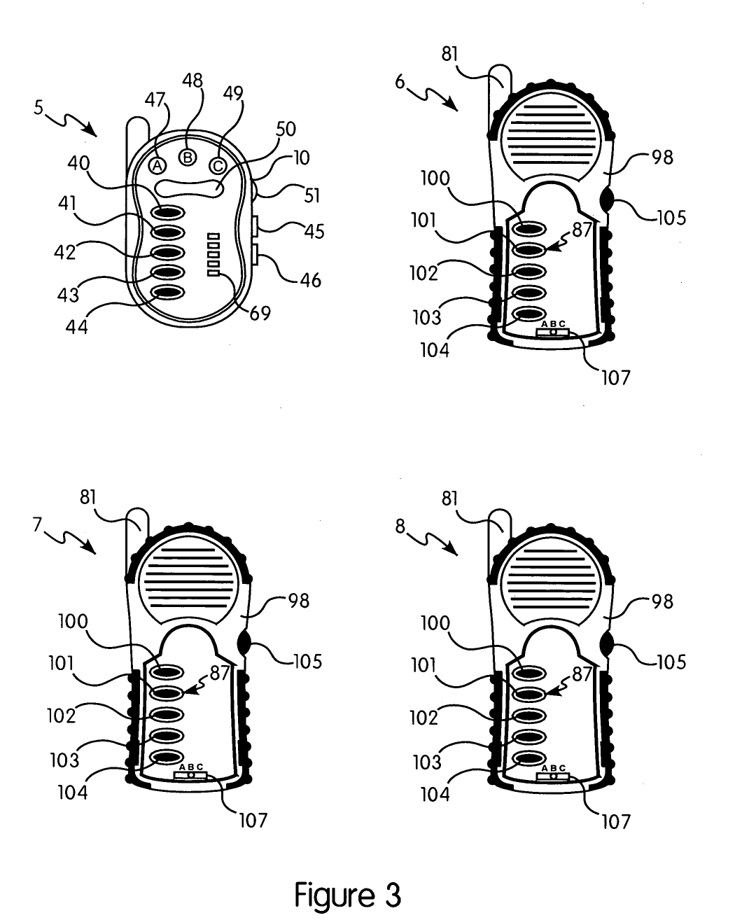

In the embodiment shown in FIGS. 1 and 3, transmitting unit 5 includes user interface 10, a processor 12, an RF transmitter 20, an antenna 21, and a power supplying arrangement 23. Although the embodiment of the system shown in FIGS. 1-3 is configured for wireless transmission of signals, it should be understood that the system is not limited in this respect and communication may alternatively be accomplished with wire or other communication means. User interface 10 may be configured to include a plurality of buttons, keys, dials, switches, etc. In the embodiment shown, user interface 10 is located on a front face of housing 35 and includes sound selection keys 40-44, volume up/down keys 45-46, channel selection keys 47-49, roaming sound key 50, and power key 51. Each of input keys 40-44 corresponds to a particular animal sound, such that when one of keys 40-44 is pressed, a corresponding switch (not shown) is activated and a signal indicating which sound was selected is sent to processor 12 via wire 55. One suitable type of processor is the Winbond W588S003 microprocessor with internal 4 MHz ring oscillator. However, processor 12 is not limited to this particular type of processor.

Upon receiving a signal from user interface 10, processor 12 processes the signal and generates a message containing information regarding the sound selected at the user interface 10. The message is then sent to one or more of receiving units 6-8 through an appropriate communication medium. In the embodiment shown, the message is sent by radio frequency communication. Therefore, the message is sent via wire 57 from processor 12 to RF transmitter 20 where it is converted into a signal that may be wirelessly transmitted to an RF receiver 60 of one or more of receiving units 6-8. One suitable RF transmitter 20 is the MICR102 manufactured by Micrel, Inc. The signal sent by RF transmitter 20 may be digitally encoded to eliminate the possibility of interference by other transmitting sources.

Transmitting unit 5 also includes power supplying arrangement 23 having a voltage source 64 and a voltage regulator 65. Voltage regulator 64 regulates the power generated by voltage source 64, which may be any source for providing suitable power. In one embodiment, voltage source 64 is comprised of three AAA batteries. Voltage supplying arrangement 23 is coupled via communication means, such as wires 67 and 68, to processing unit 10 and RF transmitter 20, respectively.

Processing unit 10, RF transmitter 20, and power supplying arrangement 23 of transmitter portion 5 are contained within housing 35, as shown in FIG. 3. In the embodiment shown, housing 35 is formed from a durable, weather-resistant material, such as plastic. Although housing 35 is shown as a small, hand-held unit that may be easily carried and operated by a user, it should be understood that housing 35 is not limited to the embodiment shown and may take on alternative configurations. Housing 35 may also include an LED display 69, which is illuminated so that a user can see what animal sounds have been selected.

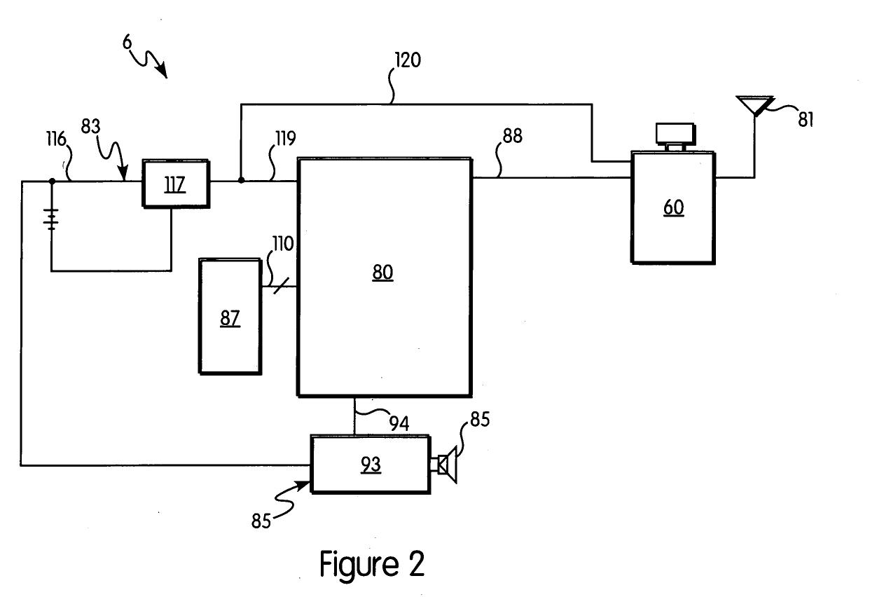

Receiving unit 5, as illustrated in FIG. 2, includes RF receiver 60, a processor 80, an antenna 81, a power supply arrangement 83, a speaker assembly 85, and a user interface 87. At this point, it should be realized that, although reference will be made to receiving unit 6 only, each of receiving units 7-8 include corresponding components. RF receiver 60, although not limited to any particular type of receiver, may be a Micrel MICRF009 receiver. When RF receiver 60 receives a message from RF transmitter 20, the message is sent to processor 80 via wire 88. One suitable processor 80 is the Winbond W588S120 microprocessor with internal 8 MHz ring oscillator. After receiving a message from RF receiver 60, processor 80 interprets the message and extracts the desired audio sound signal from audio storage medium (not separately labeled) within processor 80. Subsequently, processor 80 processes the audio sound signal and produces an output signal for an amplifier 93. The output signal, which is transferred to amplifier 93 via wire 94, is then transformed into an amplified output signal for speaker 85. The sound corresponding to the input selection at user interface 10 is then played through speaker 85. The audio storage medium contains various vocal animal sounds, animal-to-animal contact sound and environmental contact sounds which can extracted and played through speaker 85 following a selection made on user interface 10 of transmitting unit 5 or user interface 87 or receiving unit 6. It should be understood that device 1 is not limited to any particular media or method for storing or processing sounds.

Receiving unit 6 may be configured such that it can be operated independently without the use of transmitting unit 5. Therefore, receiving unit 6 includes user interface 87 located on a front face of housing 98 and includes input keys 100-104, volume/power dial 105, and channel selection switch 107, which is movable between positions A, B and C. Each of input keys 100-104 corresponds to a particular animal sound, such that when one of keys 100-104 is pressed, a corresponding switch (not shown) is activated and a signal indicating which sound was selected is sent to processor 80 via wire 110.

Receiving unit 6 also includes power supplying arrangement 83 having a voltage source 116 and a voltage regulator 117. Voltage regulator 117 regulates the power generated by voltage source 116, which may be any source for providing suitable power. In one embodiment, voltage source 116 is comprised of four AAA batteries. Voltage supplying arrangement 83 is coupled via communication means, such as wires 119 and 120, to processor 80 and RF receiver 60, respectively.

Processor 80, RF receiver 60, power supplying arrangement 115, amplifier 93 and speaker 85 of receiving unit 6 are contained within housing 98, as shown in FIG. 3. In the embodiment shown, housing 98 is formed from a durable, water resistant material, such as plastic. However, it should be understood that housing 98 is not limited to the embodiment shown and may take on alternative configurations.

Each of receiving units 6-8 are capable of receiving signals from transmitter 5 over at least three channels A-C. As shown in FIG. 2, receiving unit 6 includes a channel selection switch 107 that may be positioned to enable receiving unit 6 to receive signals through a selected one of channels A-C. Each of receiving units 6-8 may be set to the same channel or to different channels. As previously described, transmitting unit 5 includes channel selection keys 47-49, which correspond to channels A-C, respectively. Prior to selecting one of input keys 40-44 corresponding to an animal sound, a user selects one or more of channel selection keys 47-49. Although not shown, an indicator light may be associated with each channel selection key 47-49. Therefore, a user can easily identify which channel A-C has been selected.

System 1 may be used to produce a roaming sound effect to create the illusion of an animal that is moving from one area to another. In order to create the roaming sound effect, receiving units 6-8 may be strategically placed in the environment by a user who then retreats to a remote location. In one embodiment of the invention, the roaming sound is created by setting each of receiving units 6-8 to a different channel. For example, receiving unit 6 is set to channel A, receiving unit 7 is set to channel B, and receiving unit 8 is set to channel C. The roaming sound may be implemented by sequentially selecting a first channel key followed by a first input key, selecting a second channel key followed by a second input key, and then selecting a third input key followed by a third input key. As previously described, each of input keys 40-44 corresponds to a different animal sound. Therefore, by selecting the same input button after each channel selection button, a roaming sound effect is created. In the embodiment shown in FIG. 1, transmitting unit 5 also includes a roaming sound key 50 which automatically sends a first signal indicating which sound has been selected through channel A, a second signal through channel B, and a third signal through channel C. Alternatively, signals may be sent in a reverse order; i.e. channel C, channel B, then channel A. If a left portion of roaming sound button 50 is depressed, sound will travel from A→B→C. Similarly, if a right portion of roaming sound button 50 is depressed, sound will travel from C→B→A.

In one embodiment the sound may start quietly at receiving unit 6 and reach a desired crescendo for a predetermined period of time before the volume begins to decline and fade away. Before the sound being emitted from receiving unit 6 has completely disappeared, or within a preset period of time, the same animal sound will begin to reappear on receiving unit 7. The sound will begin very quietly and again work towards a desired crescendo for a determined time before slowly fading away. A similar process may be repeated on receiving unit 8. By having various receiving units 6-8 in various locations and systematically controlling the volume, the sound will seem to roam or move from one location to another. This is a tremendous advantage to a hunter or photographer since the animal will be forced to change and reveal its location in search of the sound.

System 1 may also be used to create a flock or heard sound effect with the use of multiple receiving units 6-8. When receiving units 6-8 are set to the same channel, a signal sent through that channel from transmitting unit 5 will simultaneously reach receiving units 6-8. Therefore, a user must simply press the channel selection key corresponding to the channel selected at receiving units 6-8 and then select the input key 40-44 that corresponds to the desired animal sound.

In addition, system 1 may be configured and used so that if a second one of input keys 40-44 of transmitting unit 5 is depressed during the emission of an animal sound at one of receiving units 6-8, the animal sound will be interrupted and stopped, and a new animal sound corresponding to the second one of input keys 40-44 will be played. Similarly, if one of input keys 100-104 of one of receiving unit 6-8 is pressed during the playing of a first animal sound, the first animal sound is stopped and replaced by a second animal sound. This interrupt feature allows a user to quickly change from one sound to another.

For example, the interrupt feature may be implemented using transmitting unit 5 and receiving unit 6. In a first step, a first animal sound is selected on user interface 10 of transmitting unit 5, such as by pressing a first one of input keys 40-44 corresponding to the first selected animal sound. Next, a first signal is converted into a message capable of being transferred via RF by processor 12 and sent to receiving unit 6. When the message is received at receiving unit 6 processor 80 interprets the message and extracts the desired audio sound signal from the audio storage medium. This may be facilitated by any one of the various manners known in the art for converting a signal into an audio sound. Playback of the audio sound is then commenced and the sound is emitted through speaker 85. A second animal sound may then be selected on user interface 10, such as by pressing a second one of input keys 40-44. At this point, it should be understood that the second selected sound may be the same as the first sound or may be a different sound. A second signal, which corresponds to the second selected animal sound, is converted into a message capable of being transferred via RF by processor 12 and sent to receiving unit 6. When the message is received at receiving unit 6, processor 80 interprets the message and extracts the desired audio sound signal from the audio storage medium. Playback of the first animal sound is then interrupted and stopped, such that playback of the second sound may begin. Next, playback of the second audio sound is commenced and the sound is emitted through speaker 85. In summary, when the playback of the second sound is initiated, the first sound is stopped and replaced by the second sound.

Thus, for example, if system 1 includes various turkey calls and one of input keys 40-44 is depressed to play a yelp, the user may press a second one of input keys 40-44 to interrupt the yelp call, stop the yelp call and play a cluck call. Thus, system 1, which is simply constructed and portable, allows a user to listen to various authentic calls or sounds of individual animals for the purpose of attracting animals for viewing or hunting or for mimicking the calls or sounds of the animals.

In an additional embodiment, receiving unit 6 may be capable of producing a power-down signal when a period of time has elapsed since a message has been received from transmitting unit 5 or since a signal has been received from user interface 87. A timer or counter may be used to track a certain threshold time during which an input signal or message has not been detected. When the threshold time is reached, processor 80 generates a power-down signal to shut off the unit.

Although, for convenience, the invention has been described primarily with reference to several specific embodiments, it will be apparent to those of ordinary skill in the art that system 1 and the components thereof can be modified without departing from the spirit and scope of the invention as claimed. Such modifications are intended to be within the spirit and scope of the invention and are not intended as limiting.

What is claimed is:

1. A system for reproducing animal sounds comprising:
a transmitting unit having a user interface with at least one input selector corresponding to at least one animal sound, said transmitting unit being adapted to generate and transmit a message indicative of said at least one animal sound selected at said user interface over a communications medium;
a first receiving unit having a memory with said at least one animal sound stored therein, said first receiving unit being coupled to said communications medium for receiving said message from said transmitting unit, for extracting said at least one animal sound from said memory based on said message, and to play back said at least one animal sound; and
a second receiving unit having a memory with said at least one animal sound stored therein, said second receiving unit being coupled to said communications medium for receiving said message from said transmitting unit, for extracting said at least one animal sound from said memory based on said message, and to play back said at least one animal sound.

2. The system of claim 1, wherein said play back of said at least one animal sound occurs simultaneously at both of said first and second receiving units to produce said at least one animal sound in stereo.

3. The system of claim 1, wherein said play back of said at least one animal sound occurs sequentially at said first and second receiving units to produce a moving sound effect.

4. The system of claim 1, wherein said playback of said at least one animal sound begins at a low volume at said first receiving unit and continues to increase in volume for a predetermined amount of time before beginning to decrease in volume.

5. The system of claim 4, wherein said playback of said at least one animal sound begins at said second receiving unit as the volume decreases at said first receiving unit.

6. The system of claim 1, further comprising a third receiving unit having a memory with said at least one animal sound stored therein, said third receiving unit being coupled to said communications medium for receiving said message from said transmitting unit, for extracting said at least one animal sound from said memory based on said message, and to play back said at least one animal sound.

7. The system of claim 1, wherein said first receiving unit includes a user interface having at least one input selector corresponding to at least one animal sound for sending a signal to a processor indicative of a selected at least one animal sound.

8. The system of claim 1, wherein said second receiving unit includes a user interface having at least one input selector corresponding to at least one animal sound for sending a signal to a processor indicative of a selected at least one animal sound.

9. The system of claim 7, wherein said message received by said first receiving unit from said transmitting unit overrides said signal generated by the first receiving unit user interface.

10. The system of claim 8, wherein said message received by said second receiving unit from said transmitting unit overrides said signal generated by the second receiving unit user interface.

11. The system of claim 1, wherein said transmitting unit includes a volume control for controlling the volume of the playback of a first of at least one animal sound at the first transmitting unit and for controlling the volume of the playback of a second of at least one animal sound at the second transmitting unit.

12. The system of claim 1, wherein said first receiving unit is adapted to automatically shut down after a predetermined period of inactivity.

13. The system of claim 1, wherein said second receiving unit is adapted to automatically shut down after a predetermined period of inactivity.

14. A system for remote reproduction of animal sounds comprising:
a transmitting unit having a user interface with at least one input selector corresponding to at least one animal sound, said transmitting unit being adapted to generate and transmit a message indicative of said at least one animal sound selected at said user interface over a communications medium; and
a first receiving unit having a memory with said at least one animal sound stored therein, said first receiving unit being coupled to said communications medium for receiving said message from said transmitting unit over one of at least two channels, for extracting said at least one animal sound from said memory based on said message, and to play back said at least one animal sound;
a second receiving unit having a memory with said at least one animal sound stored therein, said second receiving unit being coupled to said communications medium for receiving said message from said transmitting unit over one of at least two channels, for extracting said at least one animal sound from said memory based on said message, and to play back said at least one animal sound.

15. The system of claim 14, wherein said first receiving unit is set to receive messages through a first of said at least two channels and said second receiving unit is set to receive messages through a second of said at least two channels.

16. The device of claim 15, wherein said transmitting unit transmits a first message indicative of a first of at least one animal sound through said first channel to said first receiving unit and a second message indicative of a second of at least one animal sound through said second channel to said second receiving unit.

17. The system of claim 14, wherein said play back of said at least one animal sound occurs simultaneously at both of said first and second receiving units to produce said at least one animal sound in stereo.

18. The system of claim 14, wherein said play back of said at least one animal sound occurs sequentially at said first and second receiving units to produce a moving sound effect.

19. The system of claim 14, wherein said playback of said at least one animal sound begins at a low volume at said first receiving unit and continues to increase in volume for a predetermined amount of time before beginning to decrease in volume.

20. The system of claim 14, wherein said playback of said at least one animal sound begins at said second receiving unit as the volume decreases at said first receiving unit.

21. The system of claim 14, further comprising a third receiving unit having a memory with said at least one animal sound stored therein, said third receiving unit being coupled to said communications medium for receiving said message from said transmitting unit, for extracting said at least one animal sound from said memory based on said message, and to play back said at least one animal sound.

22. The system of claim 14, wherein said first receiving unit includes a user interface having at least one input selector corresponding to at least one animal sound for sending a signal to a processor indicative of a selected at least one animal sound.

23. The system of claim 14, wherein said second receiving unit includes a user interface having at least one input selector corresponding to at least one animal sound for sending a signal to a processor indicative of a selected at least one animal sound.

24. The system of claim 23, wherein said message received by said first receiving unit from said transmitting unit overrides said signal generated by the first receiving unit user interface.

25. The system of claim 24, wherein said message received by said second receiving unit from said transmitting unit overrides said signal generated by the second receiving unit user interface.

26. The system of claim 14, wherein said transmitting unit includes a volume control for controlling the volume of the playback of a first of at least one animal sound at the first transmitting unit and for controlling the volume of the playback of a second of at least one animal sound at the second transmitting unit.

27. The system of claim 1, wherein said first and second receiving units are adapted to automatically shut down after a period of inactivity.

28. A method of reproducing animal sounds:
selecting a first of at least one animal sound on a user interface;
generating a first signal indicative of said first of at least one animal sound;
transmitting said first signal to a first remote receiving unit;
extracting said first of at least one animal sound from a memory within said first remote receiving unit;
commencing playback of said first of at least one animal sound;
selecting a second of said at least one animal sound on said user interface;
generating a second signal indicative of said second of at least one animal sound;
transmitting said second signal to a second remote receiving unit;
extracting said second of at least one animal sound from a memory within said second remote receiving unit;
commencing playback of said second of at least one animal sound.

29. A method for reproducing a sound of a moving animal:
setting a first receiving unit to a first one of at least two channels;
setting a second receiving unit to a second one of said at least two channels;
selecting a channel corresponding to one of said at least two channels at a remote transmitting unit;
selecting a first of at least one animal sound on a user interface at said remote transmitting unit;
generating a first signal indicative of said first of at least one animal sound;
transmitting said first signal over said channel selected at the remote transmitting unit to a first remote receiving unit;
extracting said first of at least one animal sound from a memory within said first remote receiving unit;
commencing playback of said first of at least one animal sound at said first remote receiving unit;
selecting a second channel corresponding to one of said at least two channels at a remote transmitting unit;
selecting a second of at least one animal sound on a user interface at said remote transmitting unit;
generating a second signal indicative of said second of at least one animal sound;
transmitting said second signal over said channel selected at the remote transmitting unit to said second remote receiving unit;
extracting said second of at least one animal sound from a memory within said second remote receiving unit;
commencing playback of said second of at least one animal sound at said second remote receiving unit.
